(19) United States
(12) Patent Application Publication
(10) Pub. No.: US 2026/0017550 A1
(43) Pub. Date: Jan. 15, 2026

(54) MULTIPLEXED REMOTE ENTANGLEMENT GENERATION SYSTEM AND METHOD

(71) Applicant: Nanofiber Quantum Technologies, Inc., Tokyo (JP)

(72) Inventors: Shinichi SUNAMI, Tokyo (JP); Akihisa GOBAN, Tokyo (JP)

(21) Appl. No.: 18/769,117

(22) Filed: Jul. 10, 2024

(51) Int. Cl. G06N 10/40; G06N 10/20

(52) U.S. Cl. CPC G06N 10/40; G06N 10/20

(57) ABSTRACT

The present invention includes a method of high-rate remote entanglement generation between atomic qubits in separate quantum information modules, using atom-light interface such as optical cavities in the presence of slow auxiliary operations. More particularly, the invention provides techniques to mitigate the effect of slow operations on the overall entanglement generation rate by parallelizing the auxiliary operation and entanglement generation operation, as well as a method to optimize the parameters of the cavity for higher operation rates. The method can be applied to high-rate and interconnect of multiple quantum information processing unit comprising of atomic qubits.

### BACKGROUND OF INVENTION

The present invention relates generally to distributed quantum computing and quantum repeater techniques. In particular, the present invention provides method including an optical link for a quantum computing device. Merely by way of example, the invention can be applied to a variety of applications such as secure communication, cryptography, drug discovery, optimization, machine learning and artificial intelligence, finance, weather forecasting, chemical, mechanical, electrical, civil, nuclear fusion and fission, economics, materials, and any other complex human or non-human matters.

Quantum computing is a type of computing that utilizes quantum mechanics to perform certain tasks more efficiently than classical computing. In classical computing, bits can exist in one of two states, either 0 or 1, but in quantum computing, qubits can exist in a superposition of 0 and 1 states. This and other quantum mechanical effects such as entanglement allow quantum computers to perform certain calculations substantially faster than classical computers, such as factorization of large numbers, optimization problems, and simulations of quantum systems.

However, both quantum computing and quantum repeater also have some drawbacks. One major challenge is that qubits are highly susceptible to noise and decoherence, which can cause errors in the computation and repeater operations. Therefore, quantum computers and repeaters require careful error mitigation and correction techniques to maintain the accuracy of the computation by precise control and detection of individual qubits on demand. Specifically, error mitigation and correction operations often result in overhead cost when scaled to large-scale distributed quantum computing architecture.

From the above, it is seen that techniques for improving scalability of error-corrected quantum computing and quantum repeater are desired.

### SUMMARY OF INVENTION

According to the present invention, techniques generally related to quantum computing and quantum repeater are provided. In particular, the present invention provides an optical tweezer system and method including high resolution imaging system for trapping and controlling atoms and a pair of reflectors to enable an optical cavity for a quantum computing and repeater device. In particular, the present invention provides a method of high-speed photon-mediated entanglement generation for distributed quantum computing. More particularly, the invention provides techniques to collect photons emitted from a large array of atoms efficiently in the presence of slow auxiliary operations such as qubit shuttling. Merely by way of example, the invention can be applied to a variety of applications such as cryptography, drug discovery, optimization, machine learning and artificial intelligence, finance, weather forecasting, chemical, mechanical, electrical, civil, nuclear fusion and fission, economics, materials, and any other complex human or non-human matters.

In an example, the present invention provides a quantum computer system. The system has at least one quantum computer cell system. In an example, the quantum computer cell system comprises an optical link module comprising at least a pair of optical mirrors characterized by a mirror reflectivity >90% and configured to form a cavity. In an example, the cavity has a length ranging from 1 micrometer or longer. In an example, the module has a plurality of qubits comprising a laser coolable atom such that a number of the qubits, e.g., range from one to 100,000. In an example, the module has an optical interconnect coupled to the link module. In an example, the module has a photon multiplexer device coupled to the optical interconnect. The photon multiplexer device is configured to change at least two or more photons in one or more different spatial modes into two or more photons configured in a single spatial mode.

In an example, the quantum computer cell system has a free space computing module in a computing region, the computing module having a plurality of atoms. In an example, each of the atoms is coupled to an optical tweezer, the optical tweezer being configured to move to transport one or more of the atoms from a first spatial location to a second spatial location. In an example, the system has a dynamic tweezer array configured to transport one or more qubits coupled to the cavity to the computing region and a detection system comprising a camera operably coupled to the cavity or the computing region and configured to collect one or more fluorescence photons to be sent to the detection system with a quantum efficiency, e.g., of 0.1 or higher. In an example, the system has an electrical computing system comprising an information processing unit configured to process a qubit state information captured from the detection system.

In an example, the electrical computing system is configured to identify a quantum state of the one or more qubits and is configured to decode a quantum error information from a syndrome measurement result using the information processing unit.

In an example, the present invention provides a quantum computer system. The system has at least one quantum computer cell system. In an example, the quantum computer cell system has an optical link module. In an example, the optical link has a pair of optical mirrors characterized by a mirror reflectivity >90% and configured with a reflecting surface facing each other to form a cavity, the cavity having a length, e.g., ranging from 1 micrometer to 1 centimeter or longer. In an alternative example, the optical link consists of high numerical aperture photon collection device. In an example, the system has a plurality of qubits comprising a laser coolable atom, ion, nitrogen vacancy center, silicon color center or qubit systems with an optical control capability, such that a number of the qubits range from one to 100,000, among others. In an example, the system has an optical interconnect coupled to the optical link module. In an example, the system has a photon multiplexer device coupled to the optical interconnect. The photon multiplexer device is configured to change at least two or more photons in one or more different spatial modes into two or more photons configured in a single spatial mode.

In an example, the system has a free space computing module in a computing region. The free space computing module has a plurality of atoms, each of the atoms being trapped in an optical tweezer. In an example, the optical tweezer is configured to move to transport one of more of the atoms from a first spatial location to a second spatial location. In an example, the system has a detection system operably coupled to the link and the computing region and configured to collect one or more fluorescence photons to be sent to a camera or a detector with a quantum efficiency, e.g., 0.1 or higher. In an example, the system has an electrical computing system comprising an information processing unit configured to process a qubit state information captured from the camera or the detector.

In an example, photon-mediated remote entanglement generation technique establishes the entanglement between a pair of atomic qubits in separate modules by emitting a single photon each from the qubits that are interfered detected. The emitted photon spans a qubit space in possible encodings such as time bin, polarization, frequency or others.

In an example, the successful generation of the entanglement is heralded by the photon detection patterns, such that only high-fidelity entangled qubits can be selected for subsequent computing, a heralded entanglement generation (HEG) operation. The photon detection is operated such that the two photon qubits are measured in the Bell basis, where the bases are spanned by maximally entangled states of two photon qubits.

In an example, the heralded entanglement generation is efficiently operated by utilizing an optical cavity, which enhances the probability for successfully emitting a photon from an atom. For optimal parameters, the probability reaches above 90%. For time-efficient operation, the photon emission rate must be optimized, which is the ratio of photon generation probability pₑ and the pulse duration τ. Since two photons are involved in the HEG operation, the optimization must be performed to maximize pₑ²/τ.

In an example, the rate of heralded entanglement generation is practically limited by auxiliary operations such as movement of atoms from cavity mode to free-space region, incurring orders of magnitudes larger time cost than a single photon generation operation. Mitigating this cost is possible by performing the slow operation in parallel for a large array of atoms, such as by moving multiple optical tweezers at once using acousto-optic deflectors (AODs). This time-multiplexed operation is only effective when the atom number N is large.

To make the time multiplexing more effective, atoms in the cavity mode can be partitioned into multiple regions with separate operations occurring in parallel. An example is the two-zone operation, where one array of atom operate photon generations while the other is transported at the same time. This mitigates the requirement of N significantly in the presence of slow atom transport. Another advantage is that smaller repetitions of HEG trials are sufficient to achieve optimal HEG rate, thus improving the fidelity of entangled atoms.

### BRIEF DESCRIPTION OF FIGURES

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1 is a simplified diagram illustrating an implementation of quantum computing cell device according to an example.

FIG. 2 is a more detailed diagram illustrating a quantum computing cell device according to an example of the present invention.

FIGS. 3A-B is a simplified diagram illustrating moving tweezer array with acousto-optic deflectors.

FIGS. 4A-D is a simplified diagram illustrating remote entanglement generation procedure and interface with quantum computing region.

FIGS. 5A-B is a simplified diagram illustrating an efficient operation of cavity module according to an example.

FIG. 6 is a simplified diagram illustrating a parallelized operation of cavity module according to an example.

FIGS. 7A-B is a detailed diagram illustrating the photonic networking of cavities and the operation of single cavity according to an example.

FIG. 8 is a detailed diagram illustrating more detailed operation of two cavities and the photon detection module according to an example.

FIGS. 9A-B is a plot showing the numerically simulated performance of the parallelized cavity module operation.

FIGS. 10A-C is a plot to illustrate an optimization of cavity parameters to achieve fast remote entanglement operation.

FIGS. 11A-C is a simplified diagram illustrating the scaling of the optimal cavity parameters for interconnect operation for varying cavity qualities.

### DETAILED DESCRIPTION OF THE EXAMPLES

According to the present invention, techniques generally related to quantum computing and quantum repeater are provided. In particular, the present invention provides a method of high-speed photon-mediated entanglement generation for distributed quantum computing. More particularly, the invention provides techniques to collect photons emitted from a large array of atoms efficiently in the presence of slow auxiliary operations such as qubit shuttling. Merely by way of example, the invention can be applied to a variety of applications such as cryptography, drug discovery, optimization, machine learning and artificial intelligence, finance, weather forecasting, chemical, mechanical, electrical, civil, nuclear fusion and fission, economics, materials, and any other complex human or non-human matters.

Further details of the present system and method can be found throughout the present specification and more particularly below.

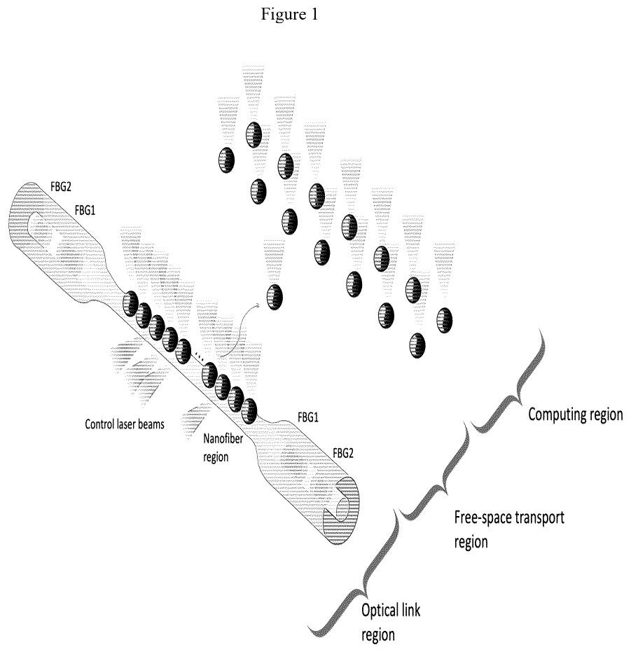

FIG. 1 is a simplified diagram illustrating a quantum computing cell device according to an example. The system comprises of optical cavity made of two mirrors, both having high reflectivity of 90% or above and may have different reflectivity. The computing cell device further comprises qubits with optical control and readout capability, such as neutral atoms trapped in optical tweezer array.

In an example, the quantum computing cell device has a dynamic tweezer array. The dynamic tweezer array comprises of acousto-optic deflectors (AODs) and laser beam for atom trapping, wherein the radiofrequency (RF) signals applied to AODs are modulated to induce the movement of the focus position of the optical tweezers, to transport the trapped atoms.

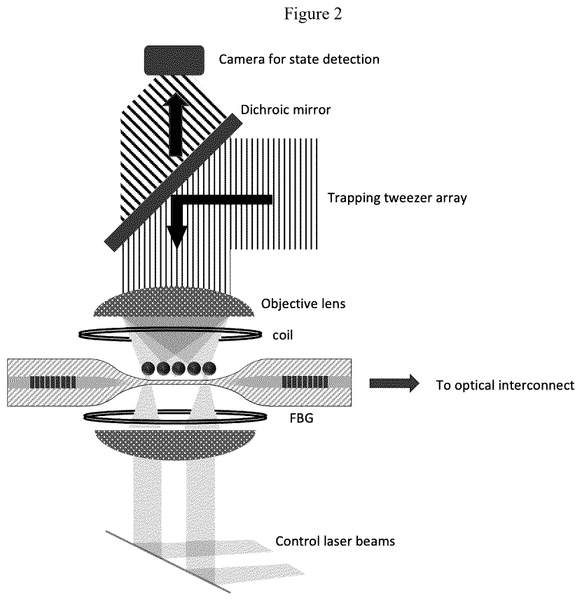

FIG. 2 is a simplified diagram illustrating the quantum computing cell device according to an example of the present invention. Two objective lenses are located above and below the link and computing module, such that the field of view covers computing and link modules. One objective lens is used to focus an array of optical tweezers, coupled by a dichroic mirror with a high-resolution imaging system comprising of high quantum efficiency camera, along with addressable control laser beam to control the quantum state of the atom qubits. The other objective lens is used to focus an array of laser beams addressing each tweezer site, with individual frequency control. In addition, optical interconnect with other cavities and single-photon generators and detectors are included. A network comprises of link modules, optical fiber, optical router (optical switches), photon detector, polarization beam splitter and other optical components.

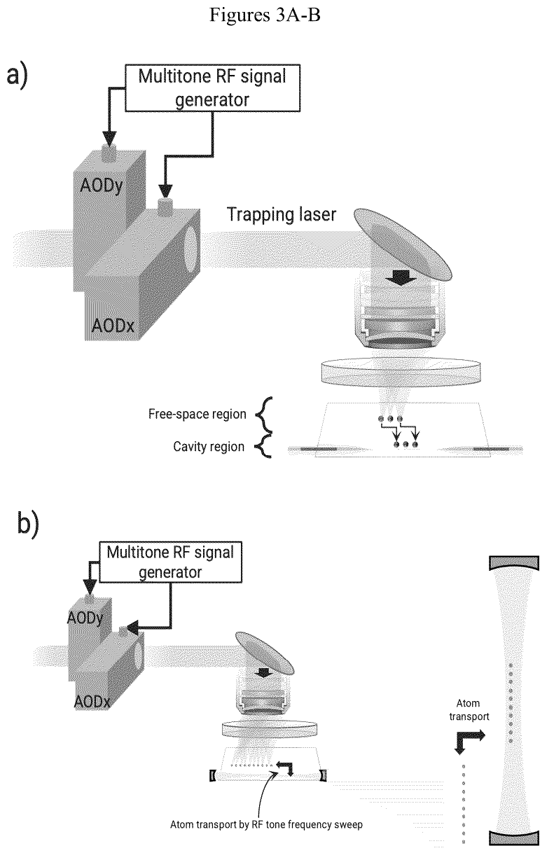

FIG. 3a is a simplified diagram illustrating a dynamic tweezer array system according to an example of the present invention. Multitone RF signals are applied to two acousto-optic deflectors (AODs), for x and y direction tweezer movements (AODx, AODy). The tones create a deflected light beam which is focused by an objective lens to create optical tweezers. By time-dependent modulation of the RF frequencies, the tweezers are moved in two dimensions, either for a single tweezer spot or simultaneously for multiple tweezer spots, as shown.

FIG. 3b is a simplified diagram illustrating the dynamic tweezer array system to move atoms in and out of cavity mode. Optical cavities, represented by a pair of mirrors surrounding the cavity mode and atoms, are placed on the focal plane (square) of the objective lens. Optical tweezers are configured to move along the plane, such that atoms are moved between free-space region with coupling to cavity mode is negligible, and the cavity region where atoms are coupled to the cavity mode with finite coupling strength g which is not negligible for the typical operations of neutral atom qubits.

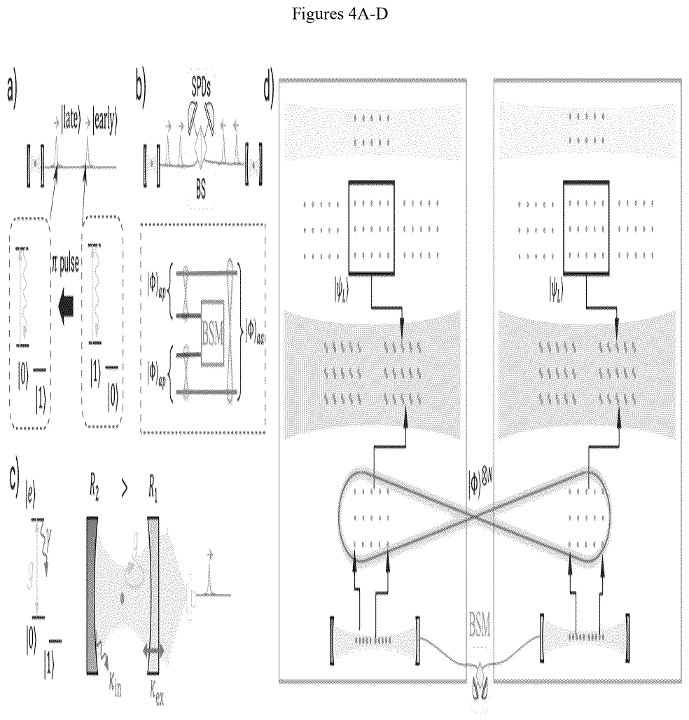

FIGS. 4A-D is a simplified illustration of the photon-assisted heralded entanglement generation (HEG) operation. a) Atom-photon entanglement is created by emitting a photon from the atom state-dependently, here the photon is in the time-bin encoding (|early>, |late>) such that its state is correlated with the atomic state. Namely, sequential photon emission for two internal states of an atom in a superposition (|0>+|1>)/√2, results in an atom-photon Bell pair (|0, early>+|1, late>)/√2. The panel b) is a typical setup for HEG with atoms and optical interface, here illustrated with free-space optical cavities. Two optical cavities in separate module are connected via fiber network to Bell state analyzer consisting of nonpolarizing beamsplitter and single-photon detectors (SPDs, half-circles). The photons are measured in the Bell basis (Bell state measurement, BSM), with a success probability for the Bell-basis projection upper bounded to 50% [1]. Successful BSM projects the atom states in the maximally entangled state, as illustrated in the equivalent quantum circuit in dashed box. The panel c) is an illustration of an atom-light interfacing with an optical cavity and a three-level atom. A transition between one of the ground states |0,1> and the excited state |e>, is coupled to the cavity with coupling rate g. Cavity is further characterized by three other rate constants, the internal loss rate, coupling to the external and atom state decay.

d) Photonic interface is integrated to neutral-atom QPU by free-space atom transport following the successful entanglement generation, such that remote transversal gate operation is performed by consuming n physical Bell pairs for physical gate teleportations where n is code block size.

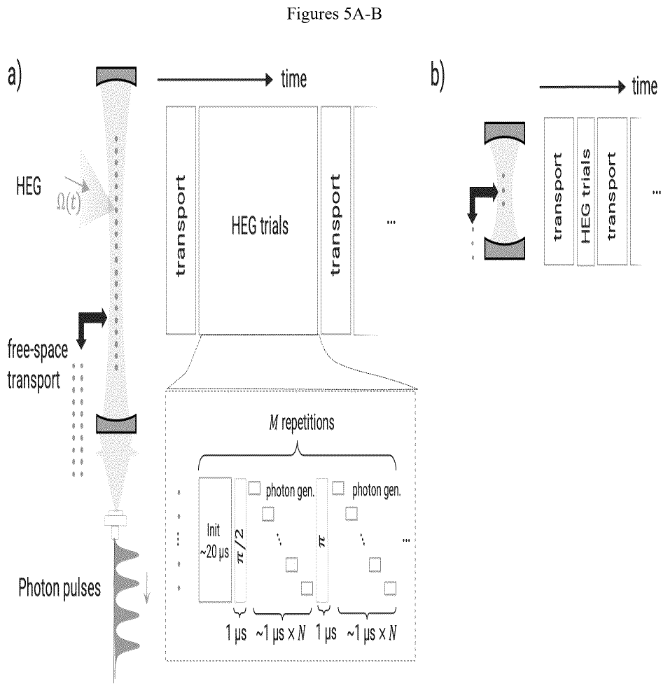

FIGS. 5A-B is a simplified illustration of the time-multiplexed HEG operation. On the left, an optical cavity is shown, in which a one or more atoms (dots) are coupled. Control laser beam (triangle) is applied to atoms to induce single-photon generation. Free-space atom transport is realized by moving optical tweezer, thereby interfacing the atoms in the cavity mode to the atoms in the free-space computing region. Cavity mode is coupled to an optical fiber, using a coupler system or by direct fiber connection, to emit photon pulses into a fiber network.

The diagram in the middle of FIG. 5 illustrates the time-multiplexed operation [2]. Atom transport is interleaved by HEG trials, which consists of M repetitions of qubit initialization, qubit pulse (π/2 and π pulses) and sequential single-photon generation operations. Panel b) is illustration of time-multiplexing with fewer number of atoms. In this case, the time cost for the atom transport dominates and significantly limit the trial rate.

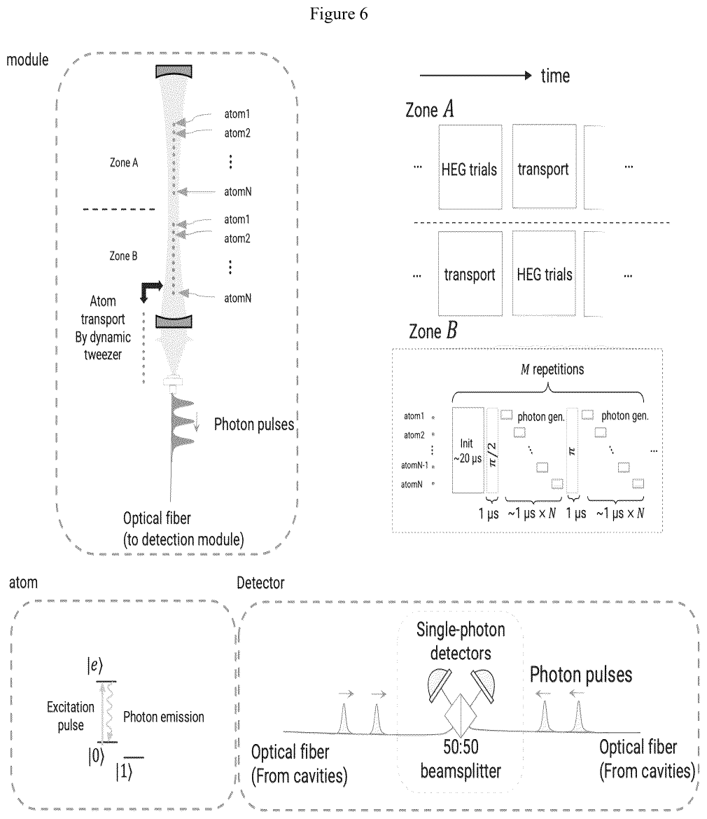

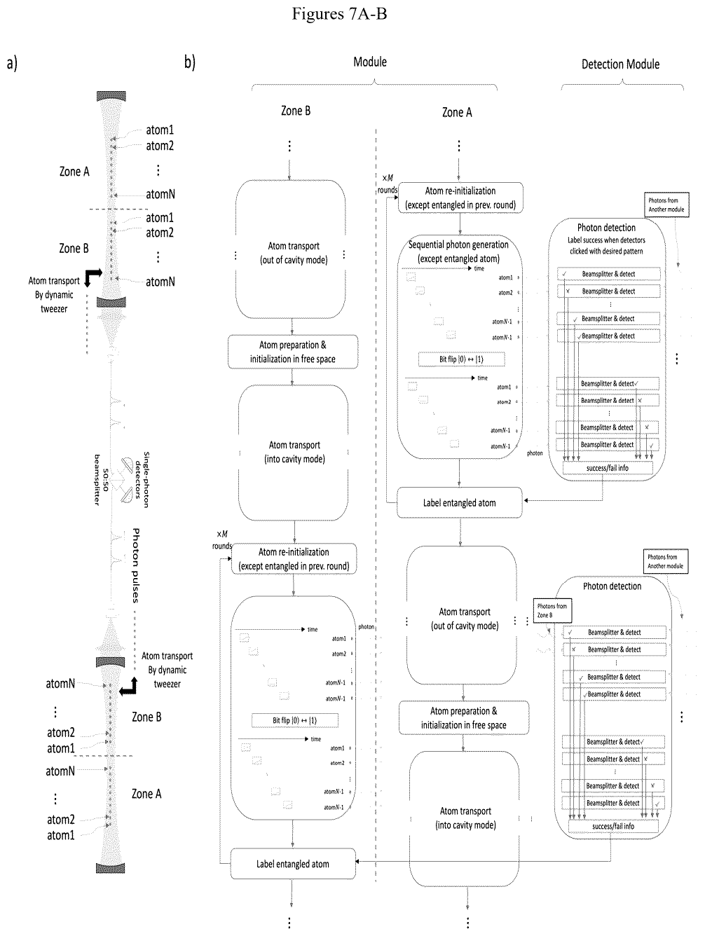

FIG. 6 is a zoned operation of the time-multiplexed HEG. Here, the cavity mode is partitioned into two regions (separated by a horizontal dashed line), zone A and B. The number of zones can be two as illustrated here, or more than two. Two zones operate atom transport and HEG trials in turn to minimize the channel downtime, as illustrated in FIGS. 7A-B. This is particularly effective for atom transport time significantly longer than the photon generation time, tₘₒᵥₑ>>tₚₕₒₜₒₙ.

In FIG. 6, the cavity atom-photon interface module, and the detector system are illustrated in dashed boxes. Also shown is the internal state structure of the atom such that the atoms contain two levels |0> and |1> to span qubit, as well as an excited state |e> which is used to emit a photon at the wavelength corresponding to the separation of the |0>↔|e>, or |1>↔|e> transition.

In FIG. 7b, optical connection to realize remote entanglement generation (FIGS. 5 and 6) is illustrated. Two cavities are connected to optical fibers, which are connected to a one or more detector modules comprising of 50:50 beamsplitters and single-photon detectors. One or more atoms in zones A and B in each cavity are configured sequentially emit photons by single-atom addressed excitation laser beams, such that photon pulse train is directed to the detection module.

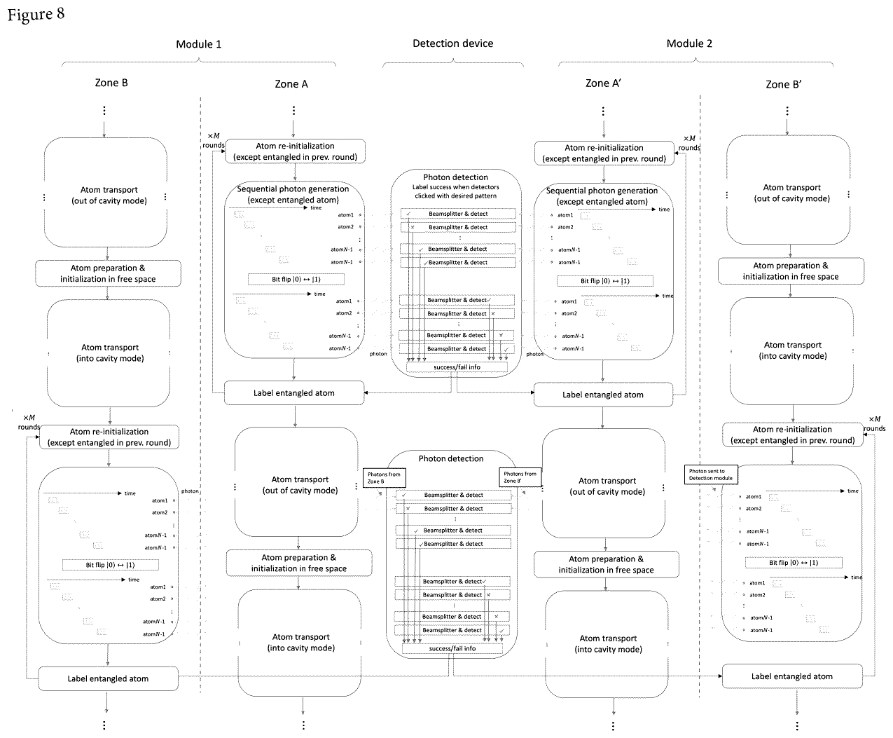

FIG. 7b illustrates, the detailed operation of the atoms in the cavities to perform the sequential photon emission from multiple atoms in the cavity, which are partitioned into zones A and B. The operation starts with atoms initialized in free-space and then transported to the cavity mode. Following the initialization, the two zones operate a sequence comprising atom transport out of cavity, atom preparation and initialization in free space, atom transport into cavity, atom re-initialization to initialize the qubit state to a high-fidelity state such as |0 . . . 0>. The zones A and B are configured to avoid operating the photon emission at the same time, such that fiber network is used only by one of the zones at a given time. Photon detection module detects the photons emitted from the atoms in the cavities, and provides classical information about the success or the failure of the photon detections with desired detection patterns. FIG. 8 illustrates the overall operation including the photon detection module and the second cavity with zones A′ and B′.

FIG. 8 is a detailed description of the remote atom-atom entanglement generation with two cavities that are each partitioned into cavity mode zones A, B and A′, B′, such that each zone contain up to N atoms where N is the number of atoms in the respective zones. The two cavities perform the operation illustrated in FIG. 7, with synchronized timing or different timing such that the photons emitted from a pair of atoms in two cavities arrive at the 50:50 beamsplitter of the photon detection module at the same time. The beamsplitter device of the photon detection module interfere the photon pulsed from two atoms in two cavities, and perform photodetection at the output ports of the beamsplitter with single-photon detectors. Since the atoms are initialized in the equal superposition state of |0> and |1> and photon generation is performed for each of the internal states at each trials and that the photon generation operation is probabilistic, we often detect only a single photon in one of two detectors. Such a detection result is the desired detection event, which we label as a success. If the photon detection for atoms labelled i in zones A and A′ (or B and B′) are both successful for the trials before and after the bit flip operation, then the entire entanglement generation for atom pair labelled i is a success, and this classical herald information is sent to the cavity module such that the in the next round of atom reinitialization and photon generation operation, this atom pair is skipped to preserve the already generated entanglement. After M rounds of reinitialization and photon emission and detection, atoms are then transported out of the cavity mode (as illustrated in FIGS. 3A-B), such that the entangled atom pair can be used for quantum information tasks. The process repeats until the entangled atom pairs are no longer needed, such as when the quantum computation completed.

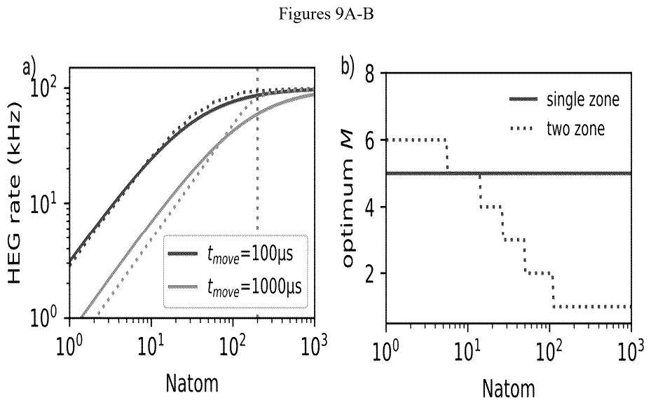

FIGS. 9A-B is the numerically simulated performance of the HEG success rate, for a particular parameter of single HEG success probability P_{HEG}=0.2 and single photon generation time tₚₕₒₜₒₙ=1 us (panel a). Solid line is the single-zone operation illustrated in FIG. 5, and dotted lines are the zoned operation in FIG. 6, and vertical dotted line is the typical atom capacity in a cavity, N=200. Atom initialization time is taken to be 20 us, and two atom transport times tₘₒᵥₑ=100 μs and tₘₒᵥₑ=1000 μs are considered. At N>100 for tₘₒᵥₑ=1000 μs and N>10 for tₘₒᵥₑ=100 μs, two-zone operation gives better performance. Also shown in panel b) is the number of repetition M that optimizes the HEG rate, used in panel a. Zoned operation require less repetition M, thereby reducing the source of decoherence to qubits.

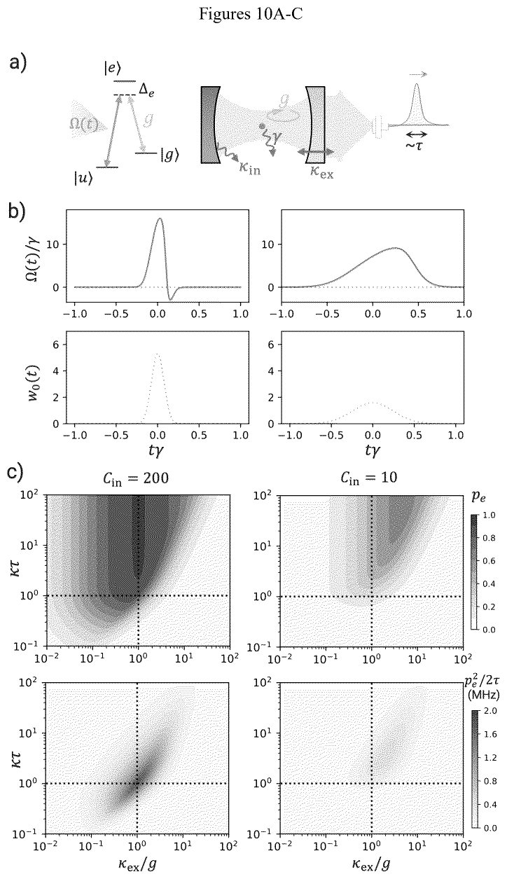

FIGS. 10A-C illustrates the optimization of cavity parameters to achieve optimal HEG generation rate given cavity and atom parameters, (g, κᵢₙ and γ). In panel a), we consider the pulse time tau and external coupling rate of the cavity κₑₓ to be controllable parameters, which is the case for optical cavity implementations. Panel a) is the setup of the atomic levels and cavity coupling. As depicted on the left, atom has three levels |u>, |g>, |e>. Atom-cavity coupling rate is g, and may be detuned from |e>↔|g> atomic transition by Δₑ. The |u>↔|e> transition, with possible detuning Δₑ, is driven by laser beam with time-dependent Rabi frequency Ω(t) controlled by time-dependent laser intensity and phase.

FIG. 10 panel a middle is a one-sided optical cavity with left mirror having near-unity reflectivity and right mirror having lower reflectivity, for directed photon extraction. A one or more atoms (dot in the middle) is coupled to the cavity. Light is confined in the cavity with enhanced atom-light coupling g, with finite dissipation κᵢₙ and coupling to the external propagating mode κₑₓ.

FIG. 10 panel b illustrates the control pulse Ω(t) to obtain Gaussian-wavepacket photon with temporal mode function w₀(t) [3,4], for pulse widths τ=1.5 τ_{c} (left) and τ=5τ_{c} (right), shown in bottom panels, where τ_{c} is the typical response time of the cavity τ_{c}=max(1/κ, κ/g²), where κ=κᵢₙ+κₑₓ[3]. The sign flip of Ω(t) on the top left panel can be achieved by adjusting the phase of the control laser pulse.

FIG. 10 panel c illustrates the photon generation probability pₑ and the HEG success rate upper bound pₑ²/2τ for a wide range of cavity and photon pulse parameters, κₑₓ/g and κτ, at two specific cavity qualities characterized by internal cooperativity Cᵢₙ=g²/2κᵢₙγ=200 (left) and 10 (right). Higher (internal) cooperativity results in large region with high pₑ, while lower cooperativity cavity require long pulse even for modest pₑ. HEG success rate upper bound pₑ²/2τ shows a global optimum near κₑₓ˜g and τ˜1/κ for high cooperativity cavity, while the optimum for lower internal cooperativity is shifted to larger κτ, requiring long pulses.

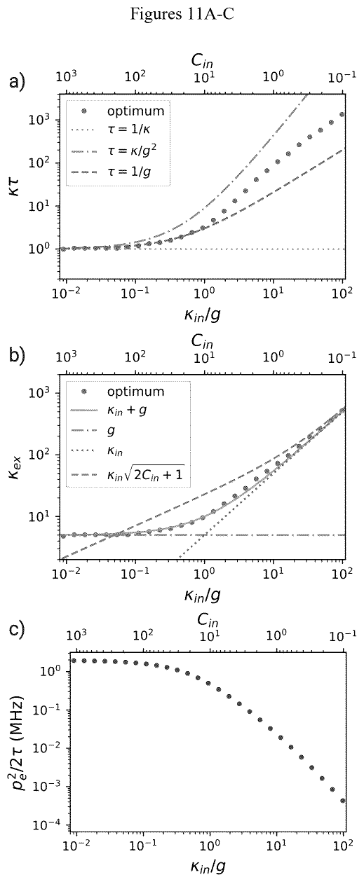

FIGS. 11A-C illustrates the scaling of the optimal pulse and cavity parameters, κₑₓ/g and κτ, for a range of cavity quality κᵢₙ/g. The optimal values are obtained by finding the parameter that gives highest HEG rate pₑ²/2τ, as illustrated in FIG. 10c bottom panels. In panel a, the dots are the optimum values of κτ for given κᵢₙ/g, with exemplary values of g/2π=5 MHz and γ/2π=0.25 MHz, while the general scaling remain the same for different parameters. The points follow scaling τ=1/g for κᵢₙ/g<1, indicating that the speed limit for efficient HEG operations is given by atom-light coupling rate. Panel b shows the optimal κₑₓ/g, which follows scaling κₑₓ=g+κᵢₙ. Panel c) shows the optimal rate pₑ²/2τ obtained for a range of κᵢₙ/g.

In an example, the present invention provides a quantum computer system. The system has at least one quantum computer cell system. In an example, the quantum computer cell system comprises an optical link module comprising at least a pair of optical mirrors characterized by a mirror reflectivity >90% and configured to form a cavity. In an example, the cavity has a length ranging from 1 micrometer or longer. In an example, the module has a plurality of qubits comprising a laser coolable atom such that a number of the qubits, e.g., range from one to 100,000. In an example, the module has an optical interconnect coupled to the link module. In an example, the module has a photon multiplexer device coupled to the optical interconnect. The photon multiplexer device is configured to change at least two or more photons in one or more different spatial modes into two or more photons configured in a single spatial mode.

In an example, the quantum computer cell system has a free space computing module in a computing region, the computing module having a plurality of atoms. In an example, each of the atoms is coupled to an optical tweezer, the optical tweezer being configured to move to transport one or more of the atoms from a first spatial location to a second spatial location. In an example, the system has a dynamic tweezer array configured to transport one or more qubits coupled to the cavity to the computing region and a detection system comprising a camera operably coupled to the cavity or the computing region and configured to collect one or more fluorescence photons to be sent to the detection system with a quantum efficiency, e.g., of 0.1 or higher. In an example, the system has an electrical computing system comprising an information processing unit configured to process a qubit state information captured from the detection system.

In an example, the electrical computing system is configured to identify a quantum state of the one or more qubits and is configured to decode a quantum error information from a syndrome measurement result using the information processing unit.

In an example, the system also has a plurality of electrical coil pairs to control a magnetic field and a magnetic field gradient at a location of the qubits.

In an example, =the pair of optical mirrors comprises at least one of a free-space bulk mirror, a fiber-based mirror, a fiber Bragg grating mirror or a photonic crystal mirror.

In an example, the cavity is characterized by a cavity mode coupled to a nanofiber region such that one or more atoms are coupled to an evanescent field of the cavity mode near a vicinity of the nanofiber between the pair of mirrors that are two fiber Bragg grating mirrors.

In an example, the plurality of the qubits characterized as first qubits are coupled to a link module and one or more second qubits are in the computing region.

In an example, the optical interconnect is coupled to a second link module in a second quantum computer cell system.

In an example, the optical interconnect is coupled to at least one or more of a single-photon generator, a photon detector, a network comprising of one or more optical cavities each of which is identical, a single-photon source, a semiconductor single-photon emitter, an optical router, an optical switch, a circulators, a photon detector, an optical homodyne or heterodyne detector, a polarization beam splitter, a coherent light source, or a squeezed light source, among other devices.

In an example, the system has a photon detector device configured with the optical interconnect. In an example, the photon detector device comprises a beam splitter and a plurality of single-photon detectors such that one or more incoming photons are measured after an interference at the beam splitter.

In an example, the system has one or more focused lasers, for a local single qubit control, that is subjected to one or more qubits that have been selected by a spatial addressability of the focused laser, or by a magnetic field generated by a pair of coils to shift a resonance frequency of the one or more qubits.

In an example, the quantum computing cell system is at least one of at least two of the quantum computing cell systems that are connected by the optical interconnect to perform a remote entanglement generation between the qubits in a separate cell systems, assisted by the optical link, to allow remote quantum gate operations for a concatenated quantum error correction operation.

In an example, the remote entanglement generation is performed by (a) a single-photon generation from the plurality of qubits and detection in the optical interconnect, (b) wherein the remote entanglement generation is performed by a reflection of a photonic qubit with at least two cavities and measurement of the qubit, (c) or wherein the remote entanglement generation is performed by a detection of photons transmitted through the cavity.

In an example, the system has one or more remote two-qubit gates performed between a pair of logical qubits of at least two quantum computing cell systems including the quantum computing cell system by performing a quantum gate teleportation or photon-assisted remote two-qubit gates.

In an example, the plurality of qubits are configured to be transported in and out of the link module such that an electric field coupling of an individual qubit to the cavity is controlled in intensity from 0 to g_max, where g_max is a maximum at a center of the cavity where an electric field of cavity field has an amplitude at a maximum value, or the qubits move outside of a field of view of a photon collection system.

In an example, the dynamic tweezer array is configured to transport the atoms in parallel after a sequential entanglement generation operation. In an example, the dynamic tweezer array is configured to initialize the atoms in parallel after a sequential entanglement generation operation.

In an example, the plurality of atoms are transported in and out of a cavity region of the cavity while the other atoms perform a remote entanglement generation operation.

In an example, the reflectivity of an outcoupling cavity mirror, characterizing an external coupling rate of the cavity, is adjusted to improve an efficiency of an entanglement generation rate.

In an example, the one or more of the qubits is characterized by an atom state controlled by a laser beam with a time-dependent amplitude and a phase, to emit a photon in a Gaussian or a temporal probability distribution with a controllable duration.

In an example, the at least one photon is characterized with a photon pulse duration that is adjusted to improve an entanglement generation rate and a fidelity of a generated entangled state.

In an example, the present invention provides an alternative quantum computer system. The system has at least one quantum computer cell system.

In an example, the quantum computer cell system comprising an optical link module.

In an example, the module has at least a pair of optical mirrors characterized by a mirror reflectivity >90% and configured to form a cavity, e.g., the cavity has a length ranging from 1 micrometer or longer. In an example, the module has a plurality of qubits comprising a laser coolable atom such that a number of the qubits, e.g., range from one to 100,000. In an example, the module has an optical interconnect coupled to the link module and a photon multiplexer device coupled to the optical interconnect, the photon multiplexer device configured to change at least two or more photons in one or more different spatial modes into two or more photons configured in a single spatial mode

In an example, the quantum computer cell system has a free space computing module in a computing region. In an example, the computing module has a plurality of atoms. In an example, each of the atoms is coupled to an optical tweezer. In an example, the optical tweezer is configured to move to transport one or more of the atoms from a first spatial location to a second spatial location. In an example, the system has a dynamic tweezer array configured to transport one or more qubits coupled to the cavity to the computing region. In an example, the system has a detection system comprising a camera operably coupled to the cavity or the computing region and configured to collect one or more fluorescence photons to be sent to the detection system with a quantum efficiency, e.g., of 0.1 or higher. In an example, the system has an electrical computing system comprising an information processing unit configured to process a qubit state information captured from the detection system. In an example, one or more of the qubits are configured for a remote entanglement generation operation.

References:
a. [1] S. Barrett et al., Phys. Rev. A 71, 060310(R) (2005)
b. [2] W. Huie et al., Phys. Rev. Res. 3, 043154 (2021)
c. [3] G. Vasilev et al., New J. Phys. 12, 063024 (2010)
d. [4] T. Utsugi et al., Phys. Rev. A 106, 023712 (2022)
e. [5] J. Covey et al, US20240056711A1

Further details of the system can be found in commonly owned patent applications described in U.S. patent application Ser. No. 18/347,121, filed on Jul. 5 2023, commonly assigned, and hereby incorporated by reference herein. Other applications describe various aspects of components are described in U.S. patent application Ser. No. 18/325,901, filed on May 30, 2023, and 18/347,174, filed on Jul. 5, 2023, each of which is commonly assigned, and hereby incorporated by reference herein.

While the above is a full description of the specific examples, various modifications, alternative constructions, and equivalents may be used. As an example, the device can include any combination of elements described above, as well as outside of the present specification. Additionally, the terms first, second, third, and final do not imply order in one or more of the present examples. Therefore, the above description and illustrations should not be taken as limiting the scope of the present invention which is defined by the appended claims.

1. A quantum computer system comprising:
at least one quantum computer cell system, quantum computer cell system comprising:
an optical link module comprising:
at least a pair of optical mirrors characterized by a mirror reflectivity >90% and configured to form a cavity, the cavity having a length ranging from 1 micrometer or longer;
a plurality of qubits comprising a laser coolable atom such that a number of the qubits range from one to 100,000;
an optical interconnect coupled to the link module;
a photon multiplexer device coupled to the optical interconnect, the photon multiplexer device configured to change at least two or more photons in one or more different spatial modes into two or more photons configured in a single spatial mode;
a free space computing module in a computing region, the computing module having a plurality of atoms, each of the atoms being coupled to an optical tweezer, the optical tweezer being configured to move to transport one or more of the atoms from a first spatial location to a second spatial location;
a dynamic tweezer array configured to transport one or more qubits coupled to the cavity to the computing region;
a detection system comprising a camera operably coupled to the cavity or the computing region and configured to collect one or more fluorescence photons to be sent to the detection system with a quantum efficiency of 0.1 or higher; and
an electrical computing system comprising an information processing unit configured to process a qubit state information captured from the detection system.

2. The system of claim 1 wherein the electrical computing system is configured to identify a quantum state of the one or more qubits and is configured to decode a quantum error information from a syndrome measurement result using the information processing unit.

3. The system of claim 1 further comprising a plurality of electrical coil pairs to control a magnetic field and a magnetic field gradient at a location of the qubits.

4. The system of claim 1 wherein the pair of optical mirrors comprises at least one of a free-space bulk mirror, a fiber-based mirror, a fiber Bragg grating mirror or a photonic crystal mirror.

5. The system of claim 1 wherein the cavity is characterized by a cavity mode coupled to a nanofiber region such that one or more atoms are coupled to an evanescent field of the cavity mode near a vicinity of the nanofiber between the pair of mirrors that are two fiber Bragg grating mirrors.

6. The system of claim 1 wherein the plurality of the qubits characterized as first qubits are coupled to a link module and one or more second qubits are in the computing region.

7. The system of claim 1 wherein the optical interconnect is coupled to a second link module in a second quantum computer cell system.

8. The system of claim 1 wherein the optical interconnect is coupled to at least one or more of a single-photon generator, a photon detector, a network comprising of one or more optical cavities each of which is identical, a single-photon source, a semiconductor single-photon emitter, an optical router, an optical switch, a circulators, a photon detector, an optical homodyne or heterodyne detector, a polarization beam splitter, a coherent light source, or a squeezed light source.

9. The system of claim 1 further comprising a photon detector device configured with the optical interconnect, the photon detector device comprising a beam splitter and a plurality of single-photon detectors such that one or more incoming photons are measured after an interference at the beam splitter.

10. The system of claim 1 further comprising one or more focused lasers, for a local single qubit control, that is subjected to one or more qubits that have been selected by a spatial addressability of the focused laser, or by a magnetic field generated by a pair of coils to shift a resonance frequency of the one or more qubits.

11. The system of claim 1 wherein the quantum computing cell system is at least one of at least two of the quantum computing cell systems that are connected by the optical interconnect to perform a remote entanglement generation between the qubits in a separate cell systems, assisted by the optical link, to allow remote quantum gate operations for a concatenated quantum error correction operation.

12. The system of claim 11 wherein the remote entanglement generation is performed by (a) a single-photon generation from the plurality of qubits and detection in the optical interconnect, (b) wherein the remote entanglement generation is performed by a reflection of a photonic qubit with at least two cavities and measurement of the qubit, (c) or wherein the remote entanglement generation is performed by a detection of photons transmitted through the cavity.

13. The system of claim 1 further comprising one or more remote two-qubit gates performed between a pair of logical qubits of at least two quantum computing cell systems including the quantum computing cell system by performing a quantum gate teleportation or photon-assisted remote two-qubit gates.

14. The system of claim 1 wherein the plurality of qubits are configured to be transported in and out of the link module such that an electric field coupling of an individual qubit to the cavity is controlled in intensity from 0 to g_max, where g_max is a maximum at a center of the cavity where an electric field of cavity field has an amplitude at a maximum value, or the qubits move outside of a field of view of a photon collection system.

15. The system of claim 1 wherein the dynamic tweezer array is configured to transport the atoms in parallel after a sequential entanglement generation operation.

16. The system of claim 1 wherein the dynamic tweezer array is configured to initialize the atoms in parallel after a sequential entanglement generation operation.

17. The system of claim 1 wherein the plurality of atoms are transported in and out of a cavity region of the cavity while the other atoms perform a remote entanglement generation operation.

18. The system of claim 1 wherein the reflectivity of an outcoupling cavity mirror, characterizing an external coupling rate of the cavity, is adjusted to improve an efficiency of an entanglement generation rate.

19. The system of claim 1 wherein the one or more of the qubits is characterized by an atom state controlled by a laser beam with a time-dependent amplitude and a phase, to emit a photon in a Gaussian or a temporal probability distribution with a controllable duration.

20. The system of claim 1 wherein the at least one photon is characterized with a photon pulse duration that is adjusted to improve an entanglement generation rate and a fidelity of a generated entangled state.

21. A quantum computer system comprising:
at least one quantum computer cell system, quantum computer cell system comprising:
an optical link module comprising:
at least a pair of optical mirrors characterized by a mirror reflectivity >90% and configured to form a cavity, the cavity having a length ranging from 1 micrometer or longer;
a plurality of qubits comprising a laser coolable atom such that a number of the qubits range from one to 100,000;
an optical interconnect coupled to the link module;
a photon multiplexer device coupled to the optical interconnect, the photon multiplexer device configured to change at least two or more photons in one or more different spatial modes into two or more photons configured in a single spatial mode;
a free space computing module in a computing region, the computing module having a plurality of atoms, each of the atoms being coupled to an optical tweezer, the optical tweezer being configured to move to transport one or more of the atoms from a first spatial location to a second spatial location;
a dynamic tweezer array configured to transport one or more qubits coupled to the cavity to the computing region;
a detection system comprising a camera operably coupled to the cavity or the computing region and configured to collect one or more fluorescence photons to be sent to the detection system with a quantum efficiency of 0.1 or higher;
an electrical computing system comprising an information processing unit configured to process a qubit state information captured from the detection system; and
wherein one or more of the qubits are configured for a remote entanglement generation operation.
